(19) United States
(12) Patent Application Publication
(10) Pub. No.: US 2024/0181534 A1
(43) Pub. Date: Jun. 6, 2024

(54) METHOD AND APPARATUS FOR BUILD SURFACE SUPPORT IN ADDITIVE MANUFACTURING SYSTEM

(71) Applicant: VulcanForms Inc., Burlington, MA (US)

(72) Inventors: Raghav Aggarwal, Somerville, MA (US); William Curtis Stone, Tewksbury, MA (US)

(73) Assignee: VulcanForms Inc., Burlington, MA (US)

(21) Appl. No.: 18/524,266

(22) Filed: Nov. 30, 2023

Related U.S. Application Data
(60) Provisional application No. 63/429,241, filed on Dec. 1, 2022.

(51) Int. Cl. B22F 12/30; B22F 12/00; B33Y 30/00; B33Y 40/00

(52) U.S. Cl. CPC B22F 12/30; B22F 12/222; B22F 12/224; B22F 12/226; B33Y 30/00; B33Y 40/00

(57) ABSTRACT

A support for a build table for use with an additive manufacturing system. Two or more actuators may be coupled to the build table and configured to move the build table in a Z direction, e.g., for deposition of multiple precursor material layers, and rotate the build table about axes parallel to a build surface, e.g., to level the build surface. Couplings for one or more actuator may provide pivotal movement about at least two orthogonal axes and linear movement along only one direction parallel to the build surface.

### RELATED APPLICATIONS

This application claims priority under 35 U.S.C. § 119(e) to U.S. Provisional Application No. 63/429,241, filed Dec. 1, 2022, the content of which is incorporated by reference in its entirety for all purposes.

### FIELD

Disclosed embodiments are generally related to methods and apparatus for supporting a build surface for additive manufacturing.

### BACKGROUND

Additive manufacturing systems employ various techniques to create three-dimensional objects from two-dimensional layers. After a layer of precursor material is deposited onto a build surface, a portion of the layer may be fused through exposure to one or more energy sources such as laser energy to create a desired two-dimensional geometry of solidified material within the layer. Next, the build surface may be indexed, and another layer of precursor material may be deposited. For example, the build surface may be moved downwardly by a distance corresponding to a thickness of a layer and a layer of precursor material deposited. This process may be repeated layer-by-layer to fuse many two-dimensional layers into a three-dimensional object.

### SUMMARY

In some additive manufacturing systems, ensuring that each layer of precursor material is suitably consistent in thickness and has a smooth top surface is important to creating a part with desired characteristics. For example, a layer of precursor material that is not suitably uniform in thickness and smooth may create a part with undesired surface roughness and/or layer thickness variations that are not acceptable. An important part to ensuring precursor layer uniformity can include ensuring that the build surface is level or otherwise suitably oriented so that precursor material can be provided on the build surface with an even thickness. In many cases, human intervention is needed to level or otherwise suitably orient a build surface so that a uniformly thick layer of precursor material can be formed on the build surface. Frequently, leveling of a build surface can require employing jack screws and/or shims to manually level the build surface. Overall, system productivity may be impacted by the need for human intervention to orient the build surface, whether at the start of a build process and/or during the process. Aspects of the disclosure provide features to permit more rapid and accurate orientation of a build table, including adjustment that need not require human intervention.

In some embodiments, a support system for moving a build surface for an additive manufacturing system includes a build table having the build surface, e.g., a surface configured to receive metal powder or other precursor material for use in the additive manufacturing process. As an example, the build surface may support precursor material so that one or more laser beams can be scanned across the precursor material on the build surface to selectively melt and fuse portions of the material. At least two actuators may be coupled to the build table and configured to move the build table in a Z direction, e.g., a direction parallel to a local gravitational field. A coupling may be provided between each actuator and the build table, with each coupling configured to provide pivotal movement about at least two orthogonal axes in a plane of the build table and to provide linear movement along only one direction parallel to the build surface. For example, the system may include a first actuator having a first coupling between the first actuator and the build table, and a second actuator having a second coupling between the second actuator and the build table. The first coupling may be configured to provide linear movement along a first direction parallel to the build surface and the second coupling may be configured to provide linear movement along a second direction parallel to the build surface. The first and second directions may be transverse to each other, e.g., at an angle of 90 degrees or less relative to each other. Thus, the first and second couplings may constrain or otherwise limit movement of the build table in directions parallel to a plane of the build surface. The first and second couplings may also provide pivotal movement of the build table relative to the actuators in a plane of the build table, e.g., a plane parallel to the plane of the build surface. Thus, the actuators may operate to level or otherwise orient the build surface in a desired way, e.g., so the build surface is perpendicular to a local gravitational field or Z direction.

In some cases, the system may include a third actuator having a third coupling between the third actuator and the build table. The third coupling may be configured to provide linear movement along a third direction parallel to the build surface, and the first, second and third directions being transverse to each other. In some embodiments, the first, second and third directions may be configured to constrain movement of the build table in directions parallel to a plane of the build surface, e.g., the first, second and third directions may lie in a common plane and be oriented at an angle of about 60 degrees relative to each other. The third actuator may be configured to move the build table in the Z direction and may assist the first and second actuators in leveling or otherwise orienting the build surface.

In some embodiments, the at least two actuators may be configured to move the build table in the Z direction for additive manufacturing of a part on the build table, and may be configured to rotate the build table about at least two transverse axes that are transverse to the Z direction to orient the build surface relative to a horizontal plane. For example, the actuators, which may include three actuators, may be configured to index or otherwise move the build table so that successive layers of precursor material can be deposited and selectively fused to build a part on the build table as well as move the build table to level or otherwise orient the build surface. Where three actuators are provided for the build table, three couplings provided between each of the three actuators and the build table may be coupled to the build table at the vertices of an equilateral triangle.

In some embodiments, a support system for leveling and raising a build surface for an additive manufacturing system includes a build table having the build surface and three actuators coupled to the build table and configured to move the build table in a Z direction for additive manufacturing of a part on the build table and configured to rotate the build table about at least two transverse axes that are transverse to the Z direction to orient the build surface relative to a horizontal plane. For example, first, second and third actuators may be coupled to the build table at respective first, second and third positions with the first, second and third positions being located at the vertices of an equilateral triangle and/or may rotate the build table about axes parallel to the build surface. The three actuators may be operable to orient and position the build surface for all phases of an additive manufacturing process, including precursor material layer deposition for multiple layers required for a build part. For example, in some cases the system may include a recoater configured move along a recoater plane to flatten powdered material on the build surface. The three actuators may be configured to rotate the build table about the at least two transverse axes to place the build surface in a plane parallel to the recoater plane, e.g., so the recoater can operate to provide a layer of precursor material on the build surface with an upper surface that is perpendicular to the Z direction.

In some cases, the system may include three couplings with each coupling between a corresponding actuator and the build table. The three couplings may each be configured to permit rotation of the build table relative to the corresponding actuator about orthogonal axes in a plane of the build table, e.g., in a plane that is parallel to the build surface. In some cases, the three couplings may be configured to restrain movement of the build table in directions parallel to the build surface. For example, at least two of the three couplings may be configured to provide pivotal movement about at least two orthogonal axes and linear movement along only one direction parallel to the build surface. In some cases, the three couplings may include first and second couplings with the first coupling configured to provide linear movement along a first direction parallel to the build surface and the second coupling configured to provide linear movement along a second direction parallel to the build surface. The first and second directions may be transverse to each other, e.g., at an angle of 90 degrees or less. In some embodiments, a third coupling may be configured to provide linear movement along only a third direction parallel to the build surface, and the first, second and third directions may be transverse to each other, e.g., so the first, second and third directions are configured to constrain movement of the build table in a plane of the build surface.

In some embodiments, a method for additive manufacturing comprises moving a build table having a build surface in a Z direction using at least two actuators and providing pivotal movement between the build table and the at least two actuators about at least two orthogonal axes in a plane of the build table. The method further comprises providing linear movement between the build table and the actuators along only one direction parallel to the build surface.

In some further embodiments, a method for leveling and raising a build surface for an additive manufacturing system comprises moving a build table having a build surface in a Z direction using three actuators and rotating the build table about at least two transverse axes that are transverse to the Z direction to orient the build surface relative to a horizontal plane.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

Other advantages and novel features of the present disclosure will become apparent from the following detailed description of various non-limiting embodiments of the disclosure when considered in conjunction with the accompanying figures.

### BRIEF DESCRIPTION OF DRAWINGS

In the drawings, each identical or nearly identical component that is illustrated in various figures may be represented by a like numeral. For purposes of clarity, not every component may be labeled in every drawing. In the drawings:

FIG. 1 shows a schematic representation of an additive manufacturing system according to some embodiments;

FIG. 2 shows a top view of a schematic representation of a build table support including three actuators and corresponding couplings, according to some embodiments;

FIG. 3 shows a side view of a schematic representation of an additive manufacturing system with a riser and build plate on a build table, according to some embodiments;

FIG. 4 shows a top view of a schematic representation of a build table support including actuators and one or more specialized kinematic couplings, according to some embodiments;

FIG. 5 shows a perspective view of a build table supported by three actuators, according to some embodiments;

FIG. 6 depicts a close-up of the coupling arrangements between actuators and the build table in FIG. 5;

FIG. 7 shows a perspective view of a coupling, according to some embodiments;

FIG. 8A shows a side schematic view of a V-block and sphere coupling, according to some embodiments;

FIG. 8B shows a top schematic view of three V-block and sphere couplings configured as in FIG. 8A;

FIG. 9A is a side schematic view of a cylinders and sphere coupling, according to some embodiments; and

FIG. 9B is a top schematic view of three cylinders and sphere couplings configured as in FIG. 9A.

### DETAILED DESCRIPTION

A common issue in additive manufacturing systems is ensuring that the build surface is suitably level or otherwise oriented during a manufacturing process so that layers of precursor material can be successively deposited in uniform thickness on the build surface. That is, additive manufacturing products are made by fusing together portions of multiple layers of precursor material, and a build surface that is not level or otherwise properly oriented can result in deposited layers of precursor material having unequal and/or variable thicknesses, which can cause the resulting fused product to have incorrect dimensions or tolerances. Furthermore, layers with unequal thicknesses may find that the laser energy provided by the system is not suitable to melt thicker portions of a layer and/or may melt too much material or too deeply into the build surface for thinner portions of a layer, as the lasers may be configured to melt preset layer thicknesses. Unfused portions of a layer can cause delamination of the final product. Currently, leveling or other adjustment in the orientation of a build surface requires human intervention and may be achieved by employing jack screws and/or shims to manually level the build surface. Human intervention in a leveling process is inefficient, e.g., because of the time involved in the leveling process and/or to make the build area safe for human presence. For example, build areas may be evacuated or purged of air so that an inert atmosphere can be established around the build surface, e.g., to reduce the likelihood of introducing impurities into a finished part. Also, the manufacturing process can generate significant heat, which may be required to dissipate before a human can safely approach a build area. Thus, the inventors have recognized a need for a build surface support system capable of adjusting an alignment of the build surface in an automated way and/or without human intervention.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

It should be understood that aspects of the invention are described herein with reference to the figures, which show illustrative embodiments. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention. For example, embodiments are described in which actuators can operate to level a build surface and move the build surface in a vertical direction, e.g., so the build surface can be indexed for multiple layers of precursor material. Also, embodiments are described in which one or more actuators are engaged with a build table using a specialized coupling that has specific movement characteristics, e.g., providing rotation in orthogonal axes and linear movement in one direction within a plane. These features can be used together or independently of each other. Similar is true of other features described which can be used alone or in any suitable combination to the extent not mutually exclusive.

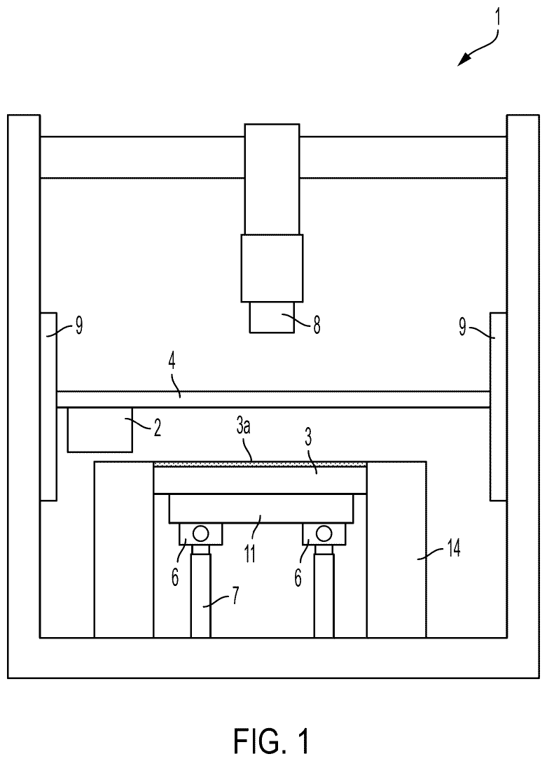

FIG. 1 depicts one embodiment of an additive manufacturing system 1 that incorporates one or more inventive features. In some embodiments, the system 1 includes a build surface 3a, which may be on a build plate 3 mounted on a build table 11, which is in turn supported by one or more actuators 7. In some cases, a riser may be provided between the build table 11 and the build plate 3, e.g., to extend a distance between the build table 11 and the build surface 3a. The one or more actuators 7 can include any appropriate number of actuators configured to support the build plate 3 and the corresponding build surface 3a at a desired position in a Z or vertical direction and/or orientation relative to an XY or horizontal plane. For example, the actuators 7 may include three actuators configured to move the build table 11 in the Z direction for the successive deposition of layers of precursor material on the build surface 3a and/or to level or otherwise control an orientation of the build plate 3 in an XY plane, e.g., to position the build surface 3a so the surface is perpendicular to a local gravitational field. A powder containment shroud 14 may at least partially, and in some embodiments completely, surround a perimeter of the build plate 3 to support a volume of precursor material, such as a volume of powder, disposed on the build plate 3 and contained within the shroud. The shroud may be supported on a base of the system or by any other appropriate portion of the system. In some embodiments, the actuators 7 may be coupled to the build plate 3 by a coupling 6. Each actuator can be activated individually, and any combination of actuators can be activated to any degree. Any appropriate type of actuator 7 may be used, including, but not limited to, ball screws, lead screws, electric motors, stepper motors, hydraulic actuators, pneumatic actuators, electric actuators, linear actuators, and/or any other appropriate type of actuator as the disclosure is not so limited.

In some embodiments, the additive manufacturing system 1 may also include an optics assembly 8 that is supported vertically above and oriented towards the build plate 3. The optics assembly may be optically coupled to one or more laser energy sources, not depicted, to direct laser energy in the form or one or more laser energy pixels onto the build surface 3a of the build plate 3. To facilitate movement of the laser energy pixels across the build surface, the optics assembly may be configured to move in one, two, or any number of directions in a plane parallel to the build surface of the build plate. To provide this functionality, the optics assembly may be mounted on a gantry, or other actuated structure, which allows the optics unit to be scanned in a plane parallel to or otherwise moved relative to the build surface of the build plate 3.

The laser energy may be used to fuse precursor material, such as a powdered metal material, in selected areas on the build surface 3a to create a desired shape of fused material on the build surface. The additive manufacturing system 1 may include a powder deposition 2 system configured to deposit and spread powdered precursor material onto the build surface 3a of the build plate 3. In some cases, the powder deposition system 2 can include a hopper and/or powder recoater, e.g., mounted on a horizontal motion stage 4 that allows the hopper and/or recoater to be moved across either a portion, or entire, surface of the build plate 3. As the hopper traverses the build surface 3a of the build plate 3, it may deposit a precursor material, such as a powder, onto the build plate 3 and a powder recoater may smooth the surface of the precursor material to provide a layer of precursor material with a predetermined thickness on top of the underlying volume of fused and/or unfused precursor material deposited during prior formation steps. The powder recoater, which may include a recoater blade and/or electrostatic recoater, can be configured to move along a recoater plane, e.g., a horizontal plane parallel to the build surface 3a, to flatten powder material on the build surface 3a. In some cases, the powder deposition system and/or powder containment shroud may be mounted on a vertical motion stage 9 that can index or otherwise move the powder deposition system and/or powder containment shroud vertically, e.g., for each layer of precursor material deposited on the build surface 3a.

In some embodiments, the actuators 7 of the build table 11 may be used to index or otherwise move the build surface 3a of the build plate 3 in a vertical direction (e.g., downwards) relative to a local direction of gravity for each layer of precursor material deposited on the build surface 3a. In such an embodiment, the powder deposition system and/or shroud may remain vertically stationary. In some cases, the powder deposition system or portions of it may be moved by the horizontal motion stage 4 to deposit and/or spread precursor material onto the exposed build surface 3a of the build plate 3 each time the build plate is indexed downwards by the actuators 7.

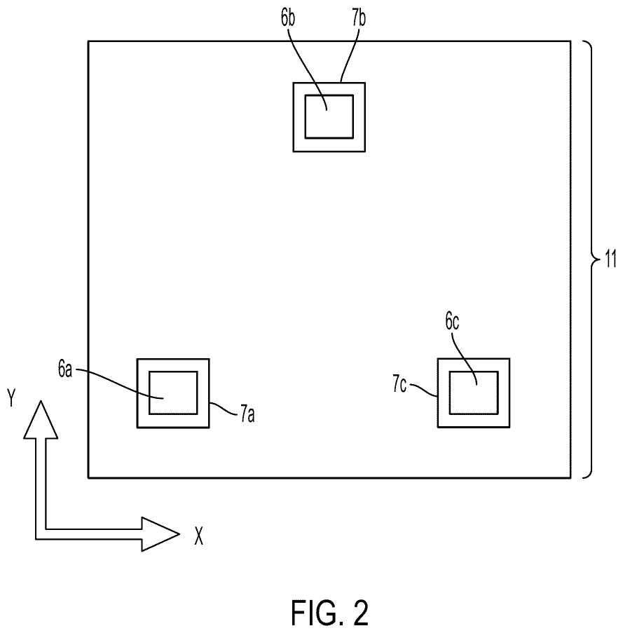

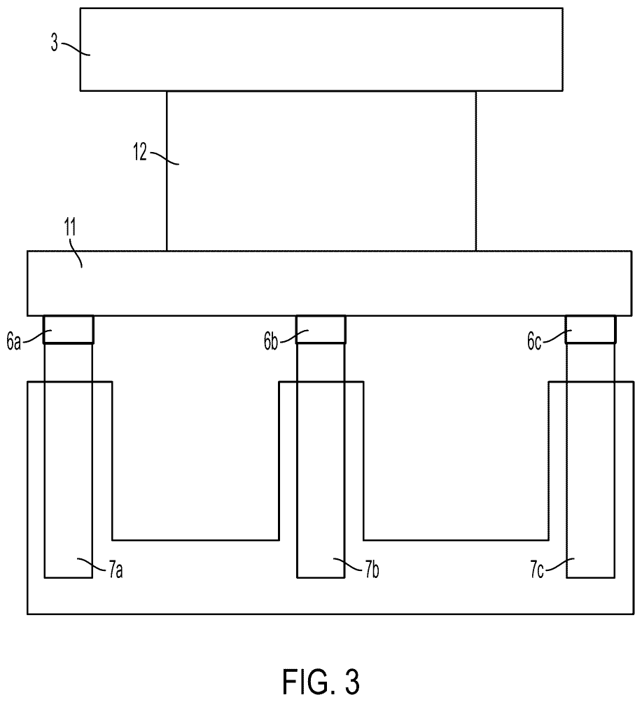

In some embodiments, a support system for moving a build surface can include actuators coupled to the build table and configured to move the build table in a Z direction for additive manufacturing of a part on the build table and configured to rotate the build table about at least two transverse axes that are transverse to the Z direction to orient the build surface relative to a horizontal plane. Movement in the Z direction may include indexed or other controlled movement of the build table so that successive layers of precursor material having uniform thickness can be deposited on the build surface. Rotational movement of the build table about two axes that are transverse to the Z direction and to each other may enable the actuators to level or otherwise orient the build surface, e.g., so as to be parallel to a plane in which a powder recoater moves. As an example, the two transverse axes can lie in a plane of the build table, e.g., a plane where actuator couplings engage with the build table and/or a plane parallel to a plane of the build surface, and with the build surface perpendicular to the Z direction, the plane in which the transverse axes lie may be parallel in the XY plane. For example, FIGS. 2 and 3 show an arrangement in which three actuators 7 are engaged with a build table 11 via respective couplings 6. In this example, the actuators 7 engage the build table 11 at vertices of a triangle, e.g., at vertices of an equilateral triangle, but can engage with the build table 11 at contact points that form any suitable shape (such as along a line, at points along a circular or elliptical shape, at vertices of any polygon, etc.). The actuators 7 can be moved along the Z direction (out of the plane of the drawing of FIG. 2 and in an up/down direction in FIG. 3) to move the build table 11 and the build surface 3a, e.g., for indexing purposes. Alternately, or in addition, the actuators 7 may be moved individually to level or otherwise orient the build surface 3a, e.g., so as to be parallel to a horizontal plane or a plane in which a recoater blade moves. For example, the actuators 7 may be configured to rotate the build table about two axes that are transverse to the Z direction, e.g., axes that lie in the XY plane, are parallel to a plane of the build surface, or other plane transverse to the Z direction. As merely one example, movement of the actuator 7b can rotate the build table 11 about the X axis, and movement of the actuator 7a can rotate the build table about an axis that extends between the actuators 7b and 7c. As will be understood, rotation about these axes may be sufficient to level or otherwise suitably orient the build surface 3a. Couplings 6 provided for each actuator 7 can be configured in any suitable way, e.g., to provide any suitable degrees of freedom and/or constraint between the actuator and build table 11. For example, couplings can provide rotation about one or more axes (e.g., in the XY or other plane, such as a plane in which the couplings 6 lie or a plane parallel to a plane of the build surface) and/or linear movement in one or more directions (e.g., in the XY or other plane, such as a plane in which the couplings 6 lie or a plane parallel to a plane of the build surface). As examples, the couplings 6 can include ball and socket couplings, hinge couplings, flexible couplings (e.g., including a resilient block of material fixed on opposed ends to the build table and actuator), other types of Maxwell and Kelvin couplings, which can also accommodate for a rotational movement without placing stress on the actuators, build table, or other fixtures on the system, etc. Also, sets of different types of couplings may be used, such as one each of so-called cone, v-groove and flat couplings for each of three actuators.

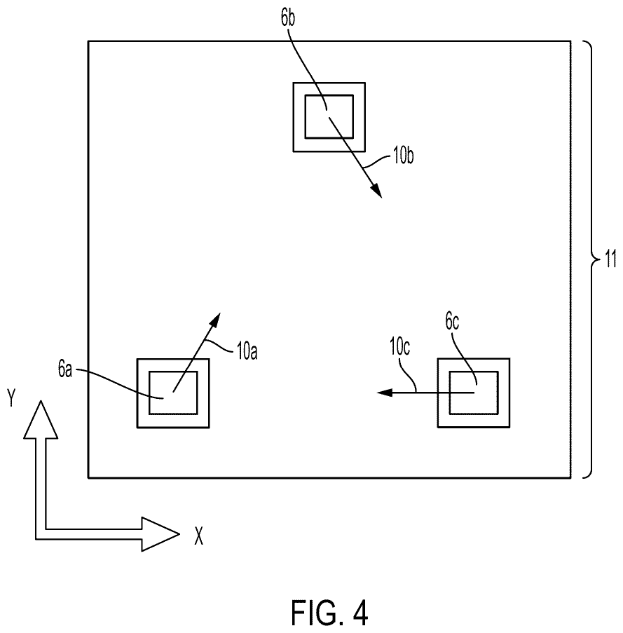

In some embodiments, one or more actuators that support a build table may be engaged with a build table using a specialized kinematic coupling or a set of specialized kinematic couplings. In some cases, a specialized kinematic coupling may be configured to provide pivotal movement about at least two orthogonal axes and linear movement along only one direction parallel to the build surface or other plane of a build table (such as a plane in which the couplings lie). For example, FIG. 4 shows an embodiment in which actuators 7 configured similarly to that in FIGS. 2 and 3 are engaged with a build table 11 using specialized kinematic couplings 6. In some embodiments, the coupling 6 for one or more actuators 7 may be configured to provide pivotal movement about at least two orthogonal axes and to provide linear movement along only one direction parallel to the build surface. For example, the couplings 6 may each provide pivotal movement of the build table 11 relative to the actuators 7 about orthogonal axes that are parallel to the build surface 3a, and may provide linear movement along a direction 10 that is parallel to the build surface 3a. In some cases, the directions of linear movement 10 provided by the couplings can be transverse to each other, e.g., arranged at an angle of 60 degrees or other suitable angle relative to each other as shown in FIG. 4. This configuration may permit the build table 11 to rotate relatively freely relative to the actuators 7 while constraining movement of the build table 11 in directions along the plane of the build surface. Such linear movement constraint may help keep a build table 11 and/or build surface 3a properly aligned with a powder containment shroud or other portion of the additive manufacturing system.

Thus, where special kinematic couplings are used, the couplings may provide first, second, and optionally third directions of movement that may be transverse to each other and constrain movement of the build plate in directions along a plane of the build surface. For example, the specialized kinematic couplings 6a, 6b, 6c in FIG. 4 can allow the build table 11 to move in a respective first direction 10a, second direction 10b, or third direction 10c in a plane parallel to the build surface. The first, second, and third directions 10 can lie in a common plane, and depending on the arrangement of the couplings, be oriented at any suitable transverse angle relative to each other. In the example of FIG. 4, when actuator 7a is actuated to move the build table 11 in a Z direction, the specialized kinematic coupling 6a can allow the build table 11 to move along a direction 10a as necessary. However, since the direction of movement 10a, 10b and/or 10c are transverse to each other, the build table 11 may be constrained or otherwise limited in its movement in the XY plane. If both actuators 6a and 6b are activated, their respective directions of movement 10a and 10b can function as bounds on the range of possible directions of movement of the build table 11. When two or more actuators with specialized kinematic couplings are coupled to the build table, all six degrees of freedom of the build table can be constrained and the different combinations and degrees of activations of the actuators can rotate the build surface as well as move the build surface in a Z direction. Any additional actuators beyond two, if provided, do not need specialized kinematic couplings to control rotational and planar movement of the build table, and can serve as additional support for the build table. In some embodiments which have a third actuator 7c, the third actuator 7c can have any type of coupling 6c that provides for rotational motion and/or linear movement of the build table parallel to the build surface. For example, in such an embodiment, the third actuator may not provide a defined third direction of movement 10c (e.g., allow for movement in any direction in the XY plane) and/or may not allow any direction of movement parallel to the build surface. Rather, two actuators 7a, 7b with special kinematic couplings 6a, 6b may allow for adjustment of the orientation of the build surface, and the third actuator 7c can provide additional support for the build table 11 and/or provide larger scale Z direction movement for the build surface. In some embodiments, the third actuator 7c can be replaced by a fixed support, e.g., where the first and second actuators operate only to level the build surface. In some cases, the third coupling 6c may be a flexible coupling, which does not allow for movement in a direction parallel to the build surface but allows the build table 11 to rotate about axes parallel to the build surface. The third actuator 7c, coupled to a flexible coupling, can move the build surface up and down in the Z direction. In some embodiments, actuators 7 in an arrangement like that in FIG. 4 may be capable of leveling or otherwise orienting the build surface 3a relative to a horizontal plane, but need not be capable of moving the build table 11 in the Z direction more than necessary for leveling or orientation purposes. For example, the actuators 7 need not be capable of moving the build table 11 for successive layers of precursor material to be deposited on the build surface 3a. Instead, a powder containment shroud and/or powder deposition system and/or optics assembly may move vertically as necessary for the build process while the build surface 3a remains relatively stationary in a vertical direction.

Where specialized kinematic couplings are employed, not all actuators for a build table need be associated with a specialized kinematic coupling. In some cases, there may be two actuators 7 coupled to the build table 11 using respective specialized kinematic couplings 6, and a third or more actuators 7 may use any type of coupling or no coupling at all. For example, a build table support system may include a first actuator with a first special kinematic coupling and a second actuator with a second special kinematic coupling which can constrain motion of the build plate 3 in the XY plane or a plane parallel to the build surface 3a and allow the build table 11 to pivot about at least two orthogonal axes in the XY plane or a plane parallel to the build surface. This configuration can allow the two actuators to level or otherwise orient the build table 11 and its build surface, e.g., to be parallel to the XY plane, while also ensuring that the build table does not move in directions parallel to the XY plane. Thus, the build table need not be indexed or moveable by the actuators in the Z direction for deposition of precursor material layers; instead, the build surface may remain vertically stationary while a powder containment shroud and/or powder deposition system move vertically to provide layers of precursor material on the build surface. In some embodiments, a third actuator with a third coupling may be provided, and may or may not include a special kinematic coupling. The third actuator and optional third coupling can provide movement of the build table in the Z direction, or the third actuator may remain stationary to provide support for the build table but no Z direction movement. Thus, this configuration can permit the actuators to move the build table to orient the build surface relative to the XY plane as well as move the build surface in the Z direction for deposition of layers of precursor material on the build surface. In this case, a powder containment shroud and/or powder deposition system need not be moveable in the Z direction, and the build surface may be indexed or moved downwardly for each layer of precursor material by the actuators. In some additive manufacturing systems, where vertical movement is performed by a powder containment shroud around the build surface as layers of precursor material are laid down during a manufacturing process, a third actuator and third coupling can give the system an additional method to support the build surface but need not be movable in the Z direction to permit deposition of multiple layers of precursor material on the build surface.

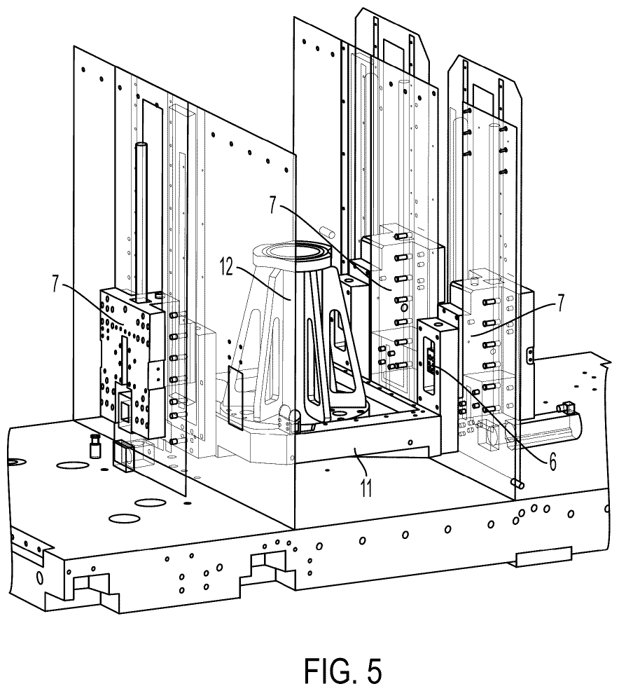

In some embodiments, a riser may be provided between the build plate 3 and build table 11, as seen in FIGS. 3 and 5 for example, but is not required. A riser 12 can include any structure mounted between the build table 11 and build plate 3 that serves to increase the height of the build surface relative to the build table while transmitting the rotations and other movements of the build table to the build plate. Thus, rotation and other movement of the build table can correspond to movement of the build plate and the build surface. Due to the distance between the build surface 3a and build table 11, rotations about axes in the XY plane of the build table 11 may cause rotations in the build plate 3 as well as movement of the build plate 3 in one or more directions in the XY plane. The magnitude of such linear offsets may scale with the magnitude of the distance between the build surface 3a and the build table 11 and/or a distance between where the couplings 6 engage the build table 11 and the build surface 3a. However, if the riser 12 is suitably rigid, the offsets can be calculated, such that the leveling of the build surface by the actuators 7 can be accurately done by determining appropriate movements of the actuators. In some cases, risers can offer benefits for a build table structure, e.g., by raising a position of the build surface without requiring modification of more complex structures such as the actuators 7. The riser 12 may also be designed to minimize space, e.g., being narrower than the build plate 3 and/or build table 11, such that extra space is available for other components of the system. The riser may be of any suitable shape and structure capable of supporting the weight of the build plate and the weight of the materials on the build surface. In some embodiments, the build table 11 may directly contact the build plate 3 without a riser 12 and/or the build table 11 may incorporate a build plate and bear the build surface itself.

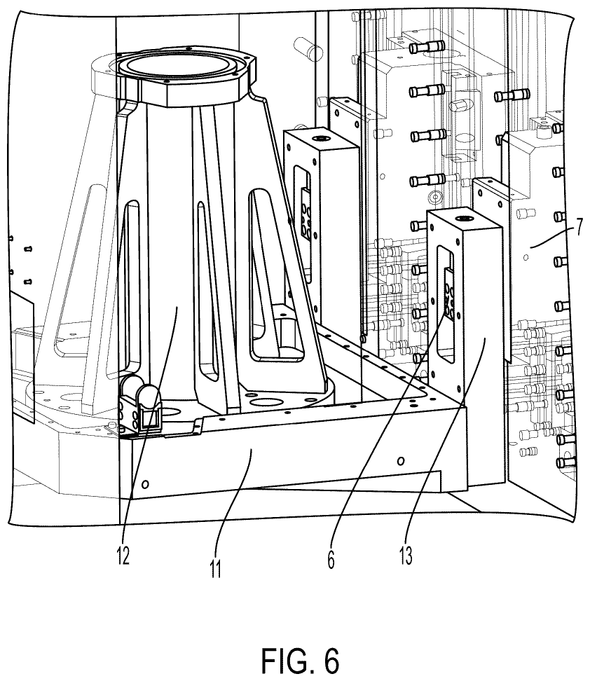

Actuators may engage with a build table 11 in any suitable location relative to the build table 11. In some embodiments, the actuators and their respective couplings may be coupled to a bottom surface of the build table, e.g., as shown in FIG. 3. However, actuators 7 and their respective couplings 6 may engage at a side of the build table 11, allowing actuators and other components, e.g., railings, wiring, and other connecting components, to be positioned along the sides of the build table 11, e.g., for easier access to components for repairs and/or modifications. For example, FIGS. 5 and 6 show an arrangement in which actuators 7 and couplings 6 are engaged with a build table 11 at the sides of the build table 11. The couplings 6 may be attached to portions of the actuators 7 which face inwards toward the build table 11, and the couplings 6 may be engaged with a link 13 attached to a side of the build table 11. In some cases, the links 13 can be attached to the build table 11 at a lower end and extend upwardly from the attachment point to the build table 11 to where the links 13 engage with a coupling 6. This may help position couplings 6 vertically closer to the build surface and reduce any amplifying effect of a riser 12 on movement of the build surface in response to movement of the actuators 7. Furthermore, the links 13 may help resist contaminants, such as powder material, from contacting the couplings 6 and affecting the functionality of the couplings 6, e.g., by increasing friction or wear on coupling bearing surfaces.

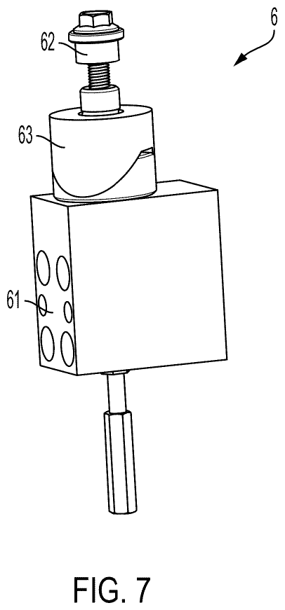

As noted above, different types of couplings can be employed for engaging an actuator to a build table. FIG. 7 shows one example of a specialized kinematic coupling 6 that may be employed to couple a link 13 to an actuator 7 in the FIGS. 5 and 6 embodiment. The link 13 may at least partially surround the coupling 6 on multiple sides, e.g., to resist entry of precursor material or other contaminants. The coupling 6 in FIG. 7 may be configured to have a lower portion 61 attached to an actuator 7 and an upper portion 62 attached to the link 13. Between the upper and lower portions 61, 62 is a coupling interface 63 that provides a desired number of degrees of freedom of motion of the upper and lower portions 61, 62 relative to each other. For example, a lower part of the coupling interface 63 may include a spherical element that engages with an upper part of the interface 63 that includes a V-block. In some cases, the components of the coupling interface 63 and or other parts of the coupling may be oriented to help shield the components from precursor material or other potentially harmful materials. For example, the V-block component may be positioned over the sphere component so that the sphere is shielded from dust or other contaminants that may cause friction or otherwise harm the function of the coupling 6. Also, by positioning the V-block component so that the faces of the V shape are oriented downwardly, dust and other material cannot collect in the V groove. Thus, coupling components may be configured so that powder, dust, etc. tend not to collect on contact surfaces, but tend to be shed or fall away from the coupling, e.g., materials may be less likely to collect on the spherical surface than in an upwardly facing V-block. As discussed more below, this type of arrangement may provide rotation of the lower and upper portions 61, 62 relative to each other about two orthogonal axes as well as linear movement in one direction, e.g., along a length of the V-block. Depending on the arrangement between the actuators 7 and the build table 11, the couplings 6 may have mounting faces on different surfaces or portions of the coupling 6, such as bottom, top and/or side surfaces. The links 13 may be adapted to accommodate different types of specialized kinematic couplings and/or other couplings.

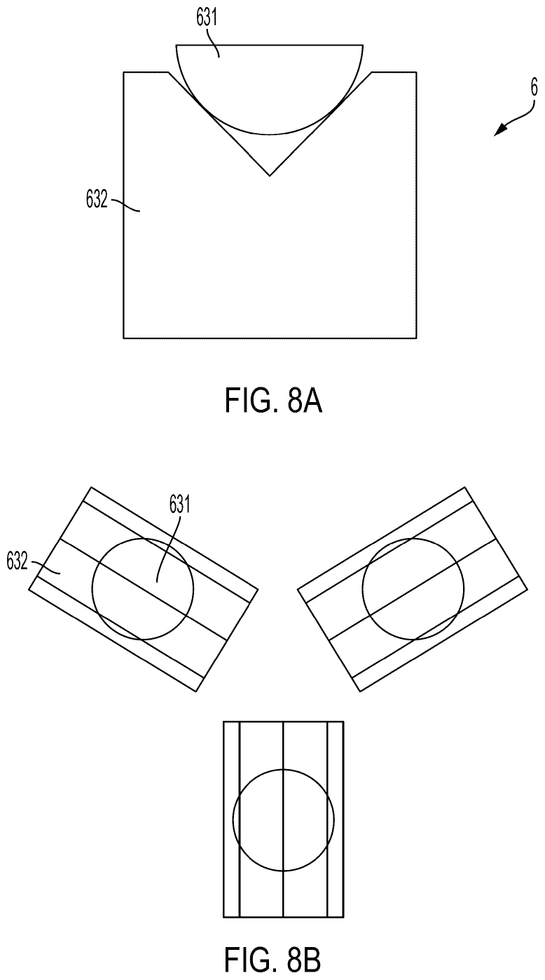

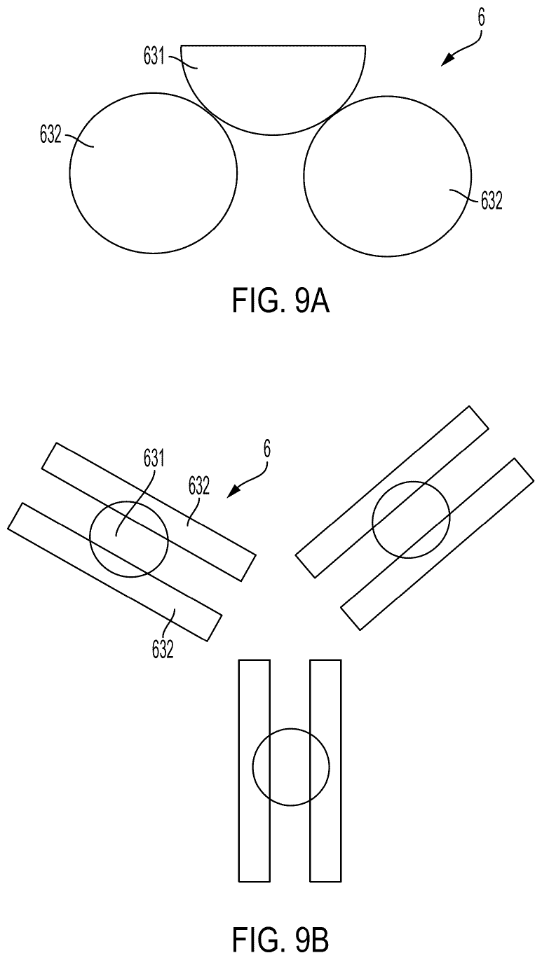

FIGS. 8A and 8B show schematic views of a kinematic coupling that includes sphere and V-block components 631, 632. As will be appreciated, engagement between the sphere and V-block groove provides rotational motion about two orthogonal axes, e.g., in a plane parallel to the base of the V-groove, while the V-block groove permits the sphere to move only in one linear direction along the length of the V-groove relative to the V-block, e.g., which can be arranged parallel to a build surface. FIG. 8B schematically depicts an arrangement in which three couplings are provided for each of three actuators and in which the linear directions of movement of the couplings are configured to be transverse to each other. This type of configuration can be employed, for example, in an arrangement like that in FIG. 4. FIGS. 9A and 9B show another possible specialized kinematic coupling 6 arrangements in which each coupling includes sphere and cylinder components 631, 632. The sphere 631 engages with portions of the cylinder components 632 and allows for rotational motion about two orthogonal axes while the cylinders allow the sphere to slide along the cylinders in only one linear direction of movement along the lengths of the cylinders. As with FIG. 8B, FIG. 9B schematically shows an arrangement in which three couplings 6 may be provided for each of three actuators 7, e.g., like that in FIG. 4. The linear directions of motion for each coupling can be oriented to be transverse to each other, e.g., to help constrain movement of a build table in directions along a plane of the build surface.

The use of special kinematic couplings with one or more actuators does not require that the same type of coupling be used with each actuator. For example, a sphere and V-block may be employed with one actuator and a sphere and cylinders coupling may be employed with another actuator, etc. Also, sets of couplings may be provided with two or more actuators to provide desired rotational movement of a build table and constrained movement in one or more directions parallel to the build surface. For example, a set of cone, V-groove and flat couplings may be used with each of three actuators for a build table. Each coupling may include a spherical component that engages with a respective cone shaped recess, V-groove and flat component for each actuator. This arrangement may provide desired constraint of movement in linear directions parallel to the build surface as well as rotational movement of the build table about transverse axes parallel to the plane of the build surface to permit proper leveling of the build surface. In short, any combination of Maxwell, Kelvin or other couplings may be employed.

In addition to the above, in some embodiments, the depicted additive manufacturing system may include one or more controllers that is operatively coupled to the various actively controlled components of the additive manufacturing system, such as the actuators 7. For example, the one or more controllers may be operatively coupled to the one or more actuators, hopper/recoater, optics assembly, the various motion stages, and/or any other appropriate component of the system. In some embodiments, the controller may include one or more processors and associated non-transitory computer readable memory. The non-transitory computer readable memory may include processor executable instructions that when executed by the one or more processors cause the additive manufacturing system to perform any of the methods disclosed herein. The one or more controllers may include sensors and/or other input devices, e.g., to determine a position, orientation or other characteristic of the build table, build surface, actuator, recoater, and control operation of one or more actuators, drives, etc. to adjust a position, orientation or other characteristic of any suitable component. For example, a controller can determine a position of the build surface, e.g., in a Z direction and/or an orientation relative to the Z direction, and operate one or more actuators to level or otherwise adjust the orientation of the build surface and/or adjust a vertical position of the build surface, e.g., in the Z direction.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A support system for moving a build surface for an additive manufacturing system, the support system comprising:
a build table having the build surface;
at least two actuators coupled to the build table and configured to move the build table in a Z direction; and
a coupling between each actuator and the build table, each coupling configured to provide pivotal movement about at least two orthogonal axes in a plane of the build table and to provide linear movement along only one direction parallel to the build surface.

2. The system of claim 1, wherein the at least two actuators includes a first actuator having a first coupling between the first actuator and the build table, and a second actuator having a second coupling between the second actuator and the build table, the first coupling configured to provide linear movement along a first direction parallel to the build surface and the second coupling configured to provide linear movement along a second direction parallel to the build surface, the first and second directions being transverse to each other.

3. The system of claim 2, wherein the first and second directions are configured to constrain movement of the build table in directions parallel a plane of the build surface.

4. The system of claim 2, wherein the at least two actuators includes a third actuator having a third coupling between the third actuator and the build table, the third coupling configured to provide linear movement along a third direction parallel to the build surface, the first, second and third directions being transverse to each other.

5. The system of claim 4, wherein the first, second and third directions are configured to constrain movement of the build table in directions parallel to a plane of the build surface.

6. The system of claim 5, wherein the first, second and third directions lie in a common plane and are oriented at an angle of about 60 degrees relative to each other.

7. The system of claim 1, wherein the at least two actuators are configured to move the build table in a Z direction for additive manufacturing of a part on the build table, and configured to rotate the build table about at least two transverse axes that are transverse to the Z direction to orient the build surface relative to a horizontal plane.

8. The system of claim 7, wherein the at least two actuators includes three actuators.

9. The system of claim 8, wherein the three couplings between each of the three actuators and the build table are coupled to the build table at the vertices of an equilateral triangle.

10. A support system for leveling and raising a build surface for an additive manufacturing system, the support system comprising:
a build table having the build surface; and
three actuators coupled to the build table and configured to move the build table in a Z direction for additive manufacturing of a part on the build table and configured to rotate the build table about at least two transverse axes that are transverse to the Z direction to orient the build surface relative to a horizontal plane.

11. The system of claim 10, further comprising three couplings, each coupling between a corresponding actuator and the build table, and the three couplings each configured to permit rotation of the build table relative to the corresponding actuator about orthogonal axes in a plane of the build table.

12. The system of claim 11, wherein the three couplings are configured to restrain movement of the build table in directions parallel to the build surface.

13. The system of claim 11, wherein at least two of the three couplings are configured to provide pivotal movement about at least two orthogonal axes and linear movement along only one direction parallel to the build surface.

14. The system of claim 13, wherein the three couplings include first and second couplings, the first coupling configured to provide linear movement along a first direction parallel to the build surface and the second coupling configured to provide linear movement along a second direction parallel to the build surface, the first and second directions being transverse to each other.

15. The system of claim 14, wherein the three couplings includes a third coupling configured to provide linear movement along only a third direction parallel to the build surface, the first, second and third directions being transverse to each other.

16. The system of claim 15, wherein the first, second and third directions are configured to constrain movement of the build table in a plane of the build surface.

17. The system of claim 10, wherein the three actuators include first, second and third actuators that are coupled to the build table at respective first, second and third positions, the first, second and third positions being located at the vertices of an equilateral triangle.

18. The system of claim 10, further comprising a recoater configured move along a recoater plane to flatten powdered material on the build surface, and wherein the three actuators are configured to rotate the build table about the at least two transverse axes to place the build surface in a plane parallel to the recoater plane.

19. A method for additive manufacturing, the method comprising:
moving a build table having a build surface in a Z direction using at least two actuators with a coupling between each actuator and the build table;
permitting pivotal movement between the build table and each coupling about at least two orthogonal axes in a plane of the build table; and
permitting linear movement between the build table and each coupling along only one direction parallel to the build surface.

20. The method of claim 19, further comprising permitting linear movement along a first direction parallel to the build surface and permitting linear movement along a second direction parallel to the build surface, the first and second directions being transverse to each other.

21. The method of claim 20, wherein the first and second directions constrain movement of the build table in directions parallel to the build surface.

22. The method of claim 20, further comprising permitting linear movement along a third direction parallel to the build surface, the first, second and third directions being transverse to each other.

23. The method of claim 20, wherein the first, second and third directions constrain movement of the build table in directions parallel to a plane of the build surface.

24. The method of claim 23, wherein the first, second and third directions lie in a common plane and are oriented at an angle of about 60 degrees relative to each other.

25. The method of claim 24, further comprising constraining movement of the build table in directions parallel to a plane of the build surface.

26. The method of claim 20, further comprising rotating the build table about at least two transverse axes that are transverse to the Z direction to orient the build surface relative to a horizontal plane.

27. The method of claim 19, further comprising fusing a precursor material disposed on the build surface with one or more laser energy pixels to form one or more parts on the build surface.

28. A part manufactured using the method of claim 19.

29. A method for leveling and raising a build surface for an additive manufacturing system, the method comprising:
moving a build table having a build surface in a Z direction using three actuators; and
rotating the build table about at least two transverse axes that are transverse to the Z direction to orient the build surface relative to a horizontal plane using the three actuators.

30. The method of claim 29, further comprising permitting rotation of the build table about orthogonal axes in a plane of the build table.

31. The method of claim 29, further comprising flattening powdered material on the build surface using a recoater and rotating the build table about the at least two transverse axes to place the build surface in a plane parallel to the recoater plane.

32. The method of claim 29, further comprising fusing a precursor material disposed on the build surface with one or more laser energy pixels to form one or more parts on the build surface.

33. A part manufactured using the method of claim 29.
